(19) United States
(12) Patent Application Publication
(10) Pub. No.: US 2025/0358497 A1
(43) Pub. Date: Nov. 20, 2025

(54) IMAGE PICKUP APPARATUS THAT ENABLES MINIATURIZATION, AND IMPROVEMENT OF CONNECTION RELIABILITY OF ELECTRICAL WIRINGS

(71) Applicant: CANON KABUSHIKI KAISHA, Tokyo (JP)

(72) Inventors: KAZUNA OYAMA, Kanagawa (JP); YOJI OYA, Kanagawa (JP); YUKO IRITANI, Tokyo (JP); KOICHI YUSA, Tokyo (JP)

(21) Appl. No.: 19/197,412

(22) Filed: May 2, 2025

(30) Foreign Application Priority Data
May 15, 2024 (JP) 2024-079452

(51) Int. Cl. H04N 23/54; G03B 17/56; H04N 23/51; H04N 23/52

(52) U.S. Cl. CPC H04N 23/54; G03B 17/563; G03B 17/566; H04N 23/51; H04N 23/52

(57) ABSTRACT

An image pickup apparatus that enables the miniaturization, and the improvement of the connection reliability of electrical wirings is provided. The image pickup apparatus includes a first electrical substrate, a second electrical substrate that has a notch portion, on which a first connector has been mounted along one side of the notch portion, and an electrical wiring that has been connected to the first connector. The first electrical substrate is disposed substantially perpendicular to the second electrical substrate in the notch portion, and a substrate surface of the first electrical substrate covers the electrical wiring.

### BACKGROUND OF THE INVENTION

### Field of the Invention

The present invention relates to an image pickup apparatus such as a digital video camera.

### Description of the Related Art

In recent years, many image pickup apparatuses such as digital video cameras are equipped with a plurality of external connection terminals for high-speed communication and Internet protocol communication, and there is a demand for technology to prevent a main body of the image pickup apparatus (an apparatus main body) from becoming larger due to the inclusion of the plurality of external connection terminals. Therefore, for example, in a technique disclosed in Japanese Laid-Open Patent Publication (kokai) No. 2021-87056, an external connection terminal portion is provided on the rear surface side of the apparatus main body, and a plurality of external connection terminals have been arranged so as not to overlap with each other when viewed from a front-and-rear direction of the apparatus main body, but to overlap with each other when viewed from a top-and-bottom direction of the apparatus main body, and to face diagonally bottom of the rear of the apparatus main body.

The technique disclosed in Japanese Laid-Open Patent Publication (kokai) No. 2021-87056 realizes miniaturization of the apparatus main body, but does not propose a configuration for reliably performing the connection of electrical wirings between electrical substrates inside the image pickup apparatus. This may result in, for example, a connector of the electrical wiring connected to a connector that has been mounted on the electrical substrate coming fall out, resulting in a loss of connection reliability. Therefore, there is an urgent need to establish a technique that is able to achieve both the miniaturization of the apparatus main body and improvement of the connection reliability of the electrical wirings.

### SUMMARY OF THE INVENTION

The present invention provides an image pickup apparatus that enables the miniaturization, and the improvement of the connection reliability of electrical wirings.

Accordingly, the present invention provides an image pickup apparatus comprising a first electrical substrate, a second electrical substrate that has a notch portion, on which a first connector has been mounted along one side of the notch portion, and an electrical wiring that has been connected to the first connector. The first electrical substrate is disposed substantially perpendicular to the second electrical substrate in the notch portion, and a substrate surface of the first electrical substrate covers the electrical wiring.

Accordingly, the present invention provides an electronic apparatus comprising a first electrical substrate, a second electrical substrate on which a first connector has been mounted, and a cable that has a second connector connected to the first connector. In a vicinity of the second connector connected to the first connector, a substrate surface of the first electrical substrate covers the cable from a direction in which the second connector is connected to the first connector.

According to the present invention, it is possible to realize the miniaturization of the image pickup apparatus main body and the improvement of the connection reliability of the electrical wirings.

Further features of the present invention will become apparent from the following description of exemplary embodiments with reference to the attached drawings.

### BRIEF DESCRIPTION OF THE DRAWINGS

FIG. 1A and FIG. 1B are first external appearance perspective views of an image pickup apparatus according to an embodiment of the present invention.

FIG. 2A and FIG. 2B are second external appearance perspective views of the image pickup apparatus.

FIG. 3 is an exploded perspective view of the image pickup apparatus.

FIG. 4 is an exploded perspective view of a main unit that constitutes the image pickup apparatus.

FIG. 5A and FIG. 5B are rear views of the main unit.

FIG. 6A and FIG. 6B are bottom views of a first electrical substrate that constitutes the main unit.

FIG. 7A and FIG. 7B are a perspective view and an exploded perspective view that partially show an internal structure of the image pickup apparatus.

FIG. 8A and FIG. 8B are views that illustrate a connection state between electrical substrates inside the image pickup apparatus.

FIG. 9A and FIG. 9B are external appearance perspective views of a sensor unit that constitutes the image pickup apparatus.

FIG. 10A and FIG. 10B are exploded perspective views of the sensor unit.

FIG. 11 is a rear view of a sensor substrate that constitutes the sensor unit.

FIG. 12 is a front view of a heat conductive sheet that constitutes the sensor unit.

FIG. 13A is a rear view of the sensor unit, and FIG. 13B is a sectional view taken in the direction of arrows W-W in the rear view of FIG. 13A.

FIG. 14 is a front view that illustrates a change point in a modification of the sensor unit.

FIG. 15 is an external appearance perspective view of an image pickup apparatus according to a modification of the image pickup apparatus shown in FIG. 1.

FIG. 16A is a partial rear view that shows a state in which a cable has been connected to an external connection terminal, and FIG. 16B is a rear view that shows an internal configuration around the external connection terminal.

### DESCRIPTION OF THE EMBODIMENTS

The present invention will now be described in detail below with reference to the accompanying drawings showing embodiments thereof.

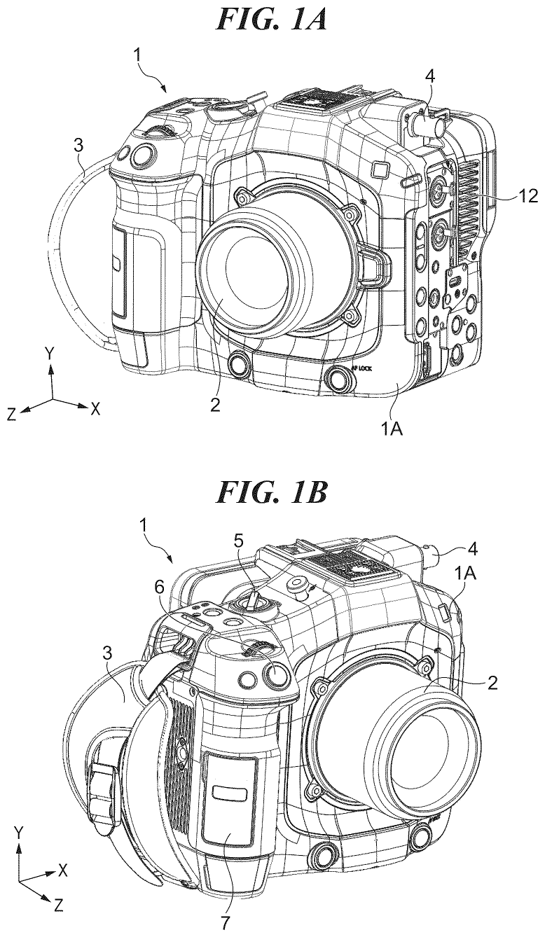

Hereinafter, an embodiment of the present invention will be described in detail with reference to the accompanying drawings. FIG. 1A and FIG. 1B are external appearance perspective views of an image pickup apparatus 1 according to the embodiment. For ease of description, as shown in FIG. 1A and FIG. 1B, a three-dimensional orthogonal coordinate system (X, Y, and Z axes) is defined with respect to the image pickup apparatus 1. The Z axis is parallel to a photographing optical axis of the image pickup apparatus 1, and a direction from the image pickup apparatus 1 toward a subject (not shown) is defined as the positive direction (+Z), and a direction opposite to the positive direction (+Z) is defined as the negative direction (−Z). The X axis is a width direction of the image pickup apparatus 1, and a direction from left toward right when viewed from the +Z side is defined as the positive direction (+X), and a direction opposite to the positive direction (+X) is defined as the negative direction (−X). The Y axis is a height direction of the image pickup apparatus 1, and a direction from the bottom surface toward the top surface is defined as the positive direction (+Y), and a direction opposite to the positive direction (+Y) is defined as the negative direction (−Y).

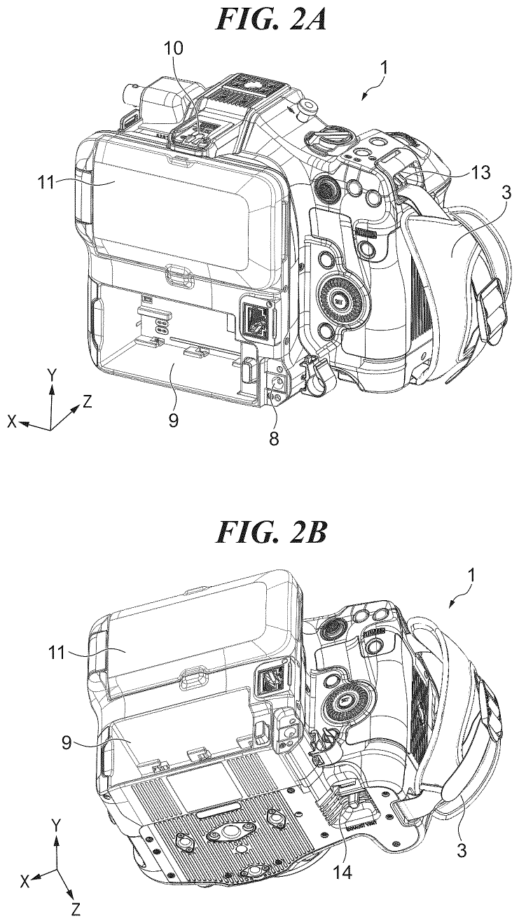

FIG. 1A is an external appearance perspective view of the image pickup apparatus 1 when viewed from the upper right front, and FIG. 1B is an external appearance perspective view of the image pickup apparatus 1 when viewed from the upper left front. FIG. 2A is an external appearance perspective view of the image pickup apparatus 1 when viewed from the upper left rear, and FIG. 2B is an external appearance perspective view of the image pickup apparatus 1 when viewed from the lower left rear.

The image pickup apparatus 1 includes an image pickup apparatus main body 1A (hereinafter, referred to as “an apparatus main body 1A”), a lens unit 2 that has been attached to the front surface (the +Z side) of the apparatus main body 1A, and a grip belt 3 that has been attached to the left side surface (the −X side) of the apparatus main body 1A. The lens unit 2 is a so-called interchangeable lens that is capable of being replaced by a user operation. The grip belt 3 is a member that assists a user so that the user is able to stably hold the image pickup apparatus 1, and is capable of being attached to and detached from the apparatus main body 1A. By using the grip belt 3 to stabilize the user's hand holding the image pickup apparatus 1, the user is able to perform photographing while firmly holding the image pickup apparatus 1 in one hand. It should be noted that the grip belt 3 is provided on the left side of the image pickup apparatus 1 because most people are generally right-handed and therefore the image pickup apparatus 1 is capable of being held in the right hand.

A holding portion for the user to hold the image pickup apparatus 1 is provided on the left side (the −X side) of the apparatus main body 1A. The holding portion is provided with a medium slot that attachably and detachably houses a storage medium such as a medium card for storing (saving) image data of photographed still images and photographed moving images (photographed videos). It should be noted that in FIG. 1B, the medium slot is hidden by a slot cover 7.

On the top surface (the +Y side) of the apparatus main body 1A, a power switch 5 for turning the power of the image pickup apparatus 1 on and off, a recording operation button 6 for starting and stopping recording (photographing) still images and moving images (videos), and an accessory attachment portion 10 that performs connecting to an accessory (not shown) have been arranged. On the rear surface (the −Z side) of the apparatus main body 1A, a DC jack 8 for performing power supply from an external power source to the image pickup apparatus 1, a battery chamber 9 for accommodating a battery (not shown), and a rear surface display unit 11 for displaying images or the like have been provided. It should be noted that a step portion that protrudes rearward (toward the −Z side) than the rear surface of the holding portion is provided on the rear surface of the image pickup apparatus 1, and the rear surface display unit 11 is disposed on the top surface (a surface on the −Z side) of the step portion.

Various kinds of operation members are provided on the right side surface (the +X side) of the apparatus main body 1A. In addition, an external connection terminal 4 for performing a communication connection with an external device is provided near the top surface of the right side surface of the apparatus main body 1A (is provided at a corner portion where the top surface and the right side surface intersect). The external connection terminal 4 is, for example, a USB terminal or an HDMI (registered trademark) terminal, but is not limited to these. A direction in which a cable (not shown) is inserted into and removed from the external connection terminal 4 is substantially parallel to the X direction (that is, is a direction substantially perpendicular to the right side surface of the apparatus main body 1A). In the image pickup apparatus 1, the external connection terminal 4 is disposed near the top surface of the right side surface of the apparatus main body 1A, thereby preventing the image pickup apparatus 1 from increasing in an overall length in the X direction and the Y direction. In addition, the external connection terminal 4 is provided on the right side, which is the opposite side of the left side of the image pickup apparatus 1 to which the grip belt 3 has been attached, and the cable is inserted into and removed from the external connection terminal 4 in a space to the right side of the image pickup apparatus 1. Therefore, the hand holding the image pickup apparatus 1 by using the grip belt 3 does not hinder the workability when inserting or removing a cable into or from the external connection terminal 4, but rather plays a role in supporting the image pickup apparatus 1 and facilitating the insertion and the removal of the cable.

The image pickup apparatus 1 is equipped with a forced air-cooling unit (details of which will be described below) including an air-cooling fan in order to cool heat generating components on substrates (not shown) contained therein. An air intake port 12 for introducing, into the inside of the apparatus main body 1A, air for cooling the inside of the apparatus main body 1A, is provided on the right side surface of the apparatus main body 1A. On the left side surface of the apparatus main body 1A, a first air exhaust port 13 for exhausting the air, which has been taken into the inside of the apparatus main body 1A from the air intake port 12, is provided on the upper side (the +Y side) of the holding portion. In addition, a second air exhaust port 14 for exhausting the air, which has been taken into the inside of the apparatus main body 1A from the air intake port 12, is provided on the bottom surface (the −Y side) of the apparatus main body 1A.

When the air-cooling fan is operated, the air is taken into the inside of the apparatus main body 1A from the air intake port 12, and the air, which has been heated by heat transfer from the heat generating components in the inside of the apparatus main body 1A, is exhausted to the outside air through the first air exhaust port 13 and the second air exhaust port 14. Here, the first air exhaust port 13 is provided at a position where the air exhausted from the first air exhaust port 13 does not hit the hand holding the holding portion. In addition, since the second air exhaust port 14 is provided on the bottom surface of the apparatus main body 1A, the second air exhaust port 14 is not capable of being seen from the front surface side (the +Z side), and therefore the aesthetic appearance of the image pickup apparatus 1 is maintained. The second air exhaust port 14 is not blocked by the floor surface even in a state where the image pickup apparatus 1 is placed on the floor, or the like, and is formed so that the exhaust air is capable of being discharged to (is capable of escaping to) the rear surface side of the image pickup apparatus 1. Therefore, even in the state where the image pickup apparatus 1 is placed on the floor, the cooling performance will not be reduced.

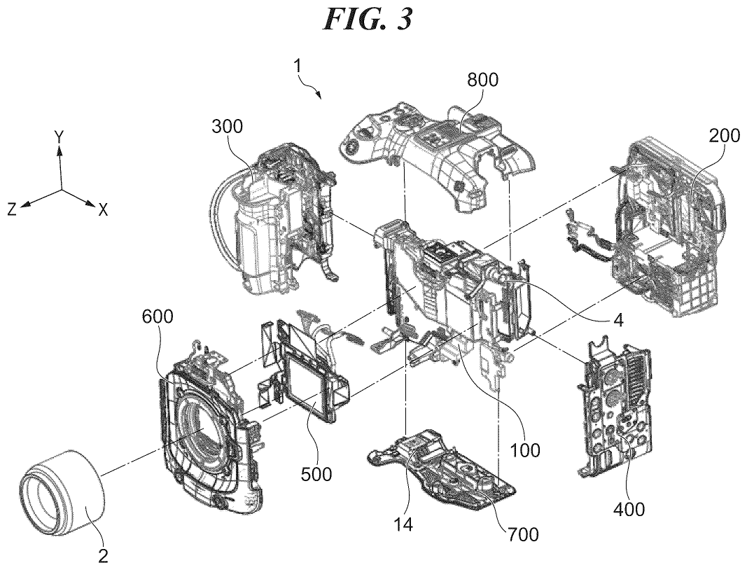

FIG. 3 is an exploded perspective view of the image pickup apparatus 1. As shown in FIG. 3, the image pickup apparatus 1 broadly includes the lens unit 2, a main unit 100, a rear unit 200, a grip unit 300, an R unit 400, a sensor unit 500, a front unit 600, a bottom unit 700, a top unit 800, and an ND unit.

The main unit 100 includes the forced air-cooling unit, which includes a duct, the air-cooling fan, etc., a control substrate for performing various kinds of controls, and the external connection terminal 4. The rear unit 200 includes the rear surface display unit 11, a liquid crystal panel, and the battery chamber 9. The grip unit 300 includes the holding portion, which includes the medium slot that houses a recording medium. The R unit 400 includes the various kinds of operation members and the air intake port 12. The sensor unit 500 includes a sensor substrate, on which an image sensor that performs photoelectric conversion on the light that has passed through the lens unit 2 has been mounted. The front unit 600 includes a mount portion to which and from which the lens unit 2 is capable of being attached and detached. The bottom unit 700 includes the second air exhaust port 14, a tripod mount, etc. The top unit 800 includes the power switch 5, etc. The ND unit includes a plurality of optical glasses for adjusting the amount of light.

The image pickup apparatus 1 is assembled, for example, by attaching the main unit 100 to the rear unit 200, and then attaching the grip unit 300 and the R unit 400 in this order. Next, the sensor unit 500, and the front unit 600 to which the ND unit has already been attached, are attached to the main unit 100, and then the top unit 800 and the bottom unit 700 are attached. When the desired lens unit 2 is attached to the front unit 600 of the apparatus main body 1A that has been completed in this way, the image pickup apparatus 1 is completed.

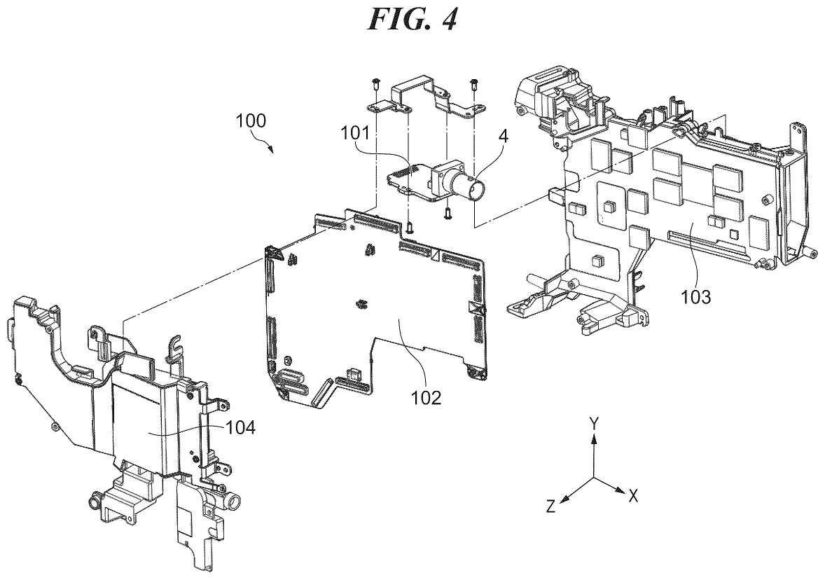

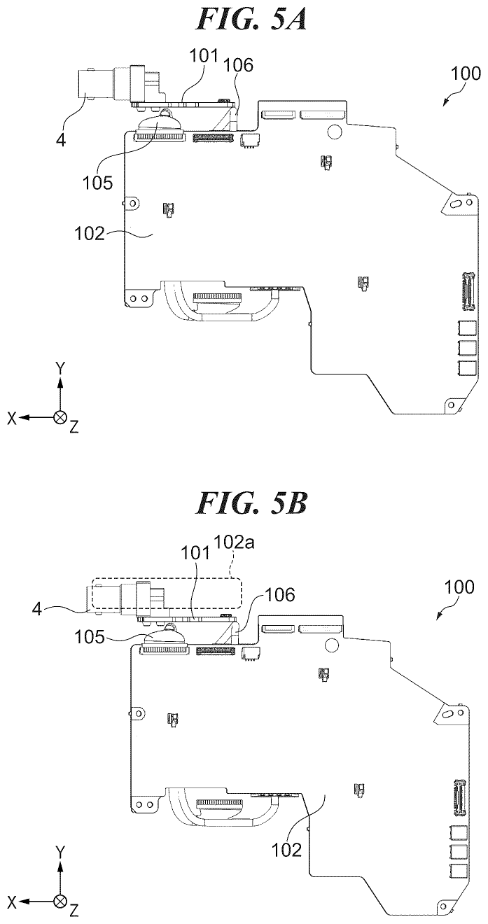

Next, an internal configuration of the image pickup apparatus 1 will be described. FIG. 4 is an exploded perspective view of the main unit 100. As shown in FIG. 4, the main unit 100 includes a first electrical substrate 101, a second electrical substrate 102, a main duct unit 103, and a sensor duct unit 104. It should be noted that the electrical substrate is a circuit substrate (a circuit board) such as a printed wiring substrate (a printed wiring board) on which electronic components and electrical components have been mounted. FIG. 5A and FIG. 5B are rear views of the main unit 100 (that is, FIG. 5A and FIG. 5B are views of the main unit 100 when viewed from the −Z side). It should be noted that the main duct unit 103 and the sensor duct unit 104 are not shown in FIG. 5A and FIG. 5B. The second electrical substrate 102 has a notch portion 102a formed therein. Two connectors for performing electrical connections with other electrical substrates have been mounted on the second electrical substrate 102 along one side of the notch portion 102a, and an electrical wiring 105 and an electrical wiring 106 are connected to the two connectors, respectively. It should be noted that each of the electrical wiring 105 and the electrical wiring 106 has a connector that corresponds to the shape of the connector that has been provided on the second electrical substrate 102, and the connectors are connected to each other.

The external connection terminal 4 has been mounted on the first electrical substrate 101. The first electrical substrate 101 is disposed in the notch portion 102a that has been provided in the second electrical substrate 102, and the external connection terminal 4 is capable of being arranged lowered to the −Y side, thereby realizing the miniaturization of the apparatus main body 1A. In addition, the first electrical substrate 101 has been arranged so that its substrate surface covers the electrical wiring 105 and the electrical wiring 106 that have been electrically connected to the second electrical substrate 102 on the +Y side (in connection directions of the electrical wiring 105 and the electrical wiring 106 with respect to the second electrical substrate 102). In this way, by configuring the substrate surface of the first electrical substrate 101 to press the electrical wiring 105 and the electrical wiring 106 against the second electrical substrate 102, the connector of the electrical wiring 105 and the connector of the electrical wiring 106 are less likely to come fall out from the connectors that have been mounted on the second electrical substrate 102, and the connection reliability of the electrical wirings is significantly improved.

It should be noted that in the present embodiment, the one side of the notch portion 102a, to which the electrical wiring 105 and the electrical wiring 106 are connected, is substantially parallel to the X axis, but the one side of the notch portion 102a may be formed so as to be inclined at a predetermined angle with respect to the X axis. This increases the length of the side available for the connection of the electrical wirings, making it possible to increase the number of poles of contact points, to which the electrical wiring 105 and the electrical wiring 106 are connected, and to connect a larger number of electrical wirings.

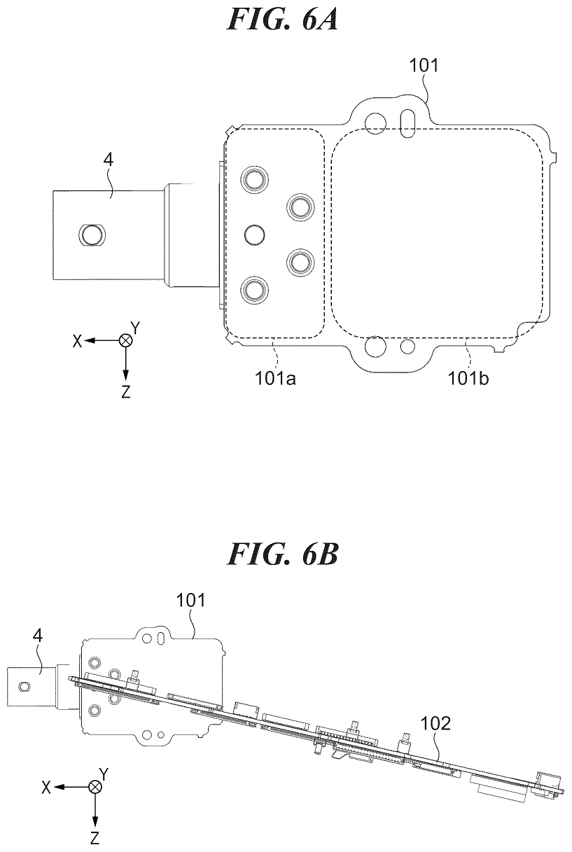

FIG. 6A is a bottom view of the first electrical substrate 101 on which the external connection terminal 4 has been mounted (a view of the first electrical substrate 101 on which the external connection terminal 4 has been mounted when viewed from the −Y direction). The first electrical substrate 101 has a mounting portion 101a on which the external connection terminal 4 has been mounted, and a non-mounting portion 101b on which no electronic or electrical components are mounted. The first electrical substrate 101 has been arranged so that the non-mounting portion 101b covers the electrical wiring 105 and the electrical wiring 106 that have been electrically connected to the second electrical substrate 102. As a result, it is possible to securely press down the electrical wiring 105 and the electrical wiring 106 by a flat surface of the non-mounting portion 101b, thereby making it possible to prevent the occurrence of defects caused by contact between the components mounted on the first electrical substrate 101, and the electrical wiring 105 and the electrical wiring 106, and thereby making it possible to improve the reliability of the electrical circuit.

FIG. 6B is a bottom view of the first electrical substrate 101 on which the external connection terminal 4 has been mounted and the second electrical substrate 102. A long side of the first electrical substrate 101 and a long side of the second electrical substrate 102 are not substantially parallel to each other, and an overlapping range (an overlapping length) of the first electrical substrate 101 and the second electrical substrate 102 when viewed from the −Y direction is wider than in the case where the long side of the first electrical substrate 101 and the long side of the second electrical substrate 102 are substantially parallel to each other. Therefore, by the first electrical substrate 101 covering the electrical wiring 105 and the electrical wiring 106 that have been electrically connected to the second electrical substrate 102 in a wider range, it is possible to enhance the effect of preventing the electrical wiring 105 and the electrical wiring 106 from coming fall out from the second electrical substrate 102.

A plurality of electrical substrates such as the second electrical substrate 102 and the sensor substrate are disposed in the inside of the image pickup apparatus 1, and during a photographing operation, the electronic components that have been mounted on the electrical substrates consume power and generate heat. In order to prevent performance degradation due to the heat generated by the electronic components, the electronic components must be kept below their guaranteed operating temperature, and therefore, a heat dissipation mechanism (a cooling mechanism) is required to prevent the electronic components from exceeding their guaranteed operating temperature.

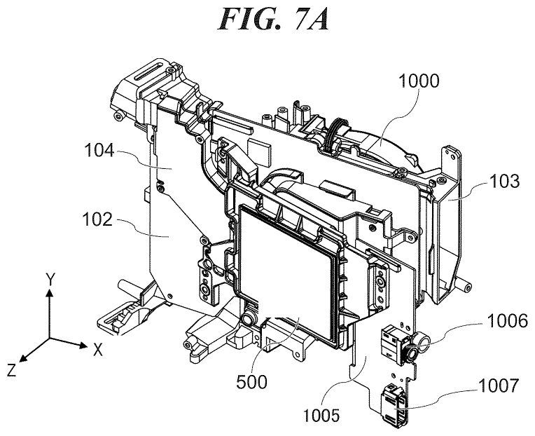

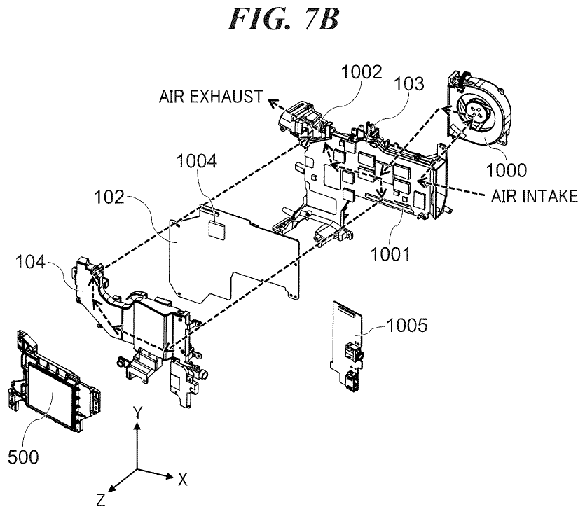

FIG. 7A is a perspective view that partially shows an internal structure of the image pickup apparatus 1, and FIG. 7B is an exploded perspective view of the structure shown in FIG. 7A. The electronic components such as a microprocessor (an MPU) that has been mounted on the second electrical substrate 102 which performs overall control of the image pickup apparatus 1, and the image sensor that has been mounted on the sensor unit 500 generate heat during a photographing operation, causing a rise in temperature. Therefore, as shown in FIG. 7A, the image pickup apparatus 1 includes the forced air-cooling unit, which includes an air-cooling fan 1000, the main duct unit 103, and the sensor duct unit 104. As shown in FIG. 7B, in the inside of the image pickup apparatus 1, the sensor unit 500, the sensor duct unit 104, the second electrical substrate 102, the main duct unit 103, and the air-cooling fan 1000 are arranged in this order from the front (the +Z side) toward the rear (the −Z side).

The flow of the air in the forced air-cooling unit is shown by dashed arrows in FIG. 7B. The air taken in from the outside by driving the air-cooling fan 1000 is supplied to the main duct unit 103, and a part of the air passes through the inside of the main duct unit 103 and is then exhausted to the outside. In addition, a part of the air taken into the main duct unit 103 passes through a connecting hole 1001 and flows into the sensor duct unit 104, and then returns to the main duct unit 103, passes through a connecting hole 1002, and is exhausted to the outside.

Here, the electronic components that have been mounted on the rear surface side (the −Z side) of the second electrical substrate 102 face the main duct unit 103. In addition, the electronic components that have been mounted on the front surface side (the +Z side) of the second electrical substrate 102, and the sensor unit 500 are disposed with the sensor duct unit 104 sandwiched therebetween. Therefore, by arranging a heat transfer member (not shown) between the electronic components and the duct, the heat generated by the electronic components and the image sensor is capable of being efficiently transferred to the main duct unit 103 and the sensor duct unit 104. The heat that has been transferred to the main duct unit 103 and the sensor duct unit 104 is transferred to the air flowing inside and is discharged to the outside.

Next, a heat dissipation means (a heat dissipation path) provided with respect to a heat generating component that is not capable of being arranged so as to face the duct, such as an electronic component 1004, for reasons such as avoiding other components will be described.

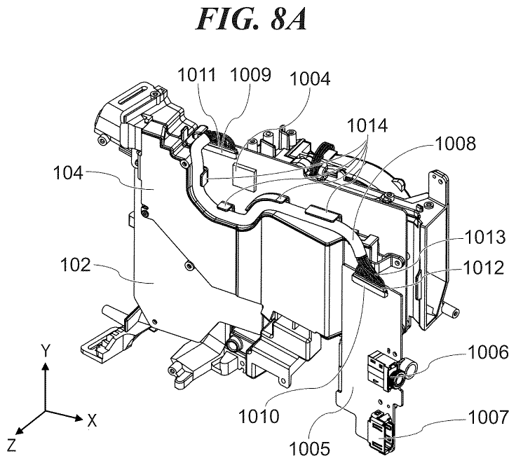

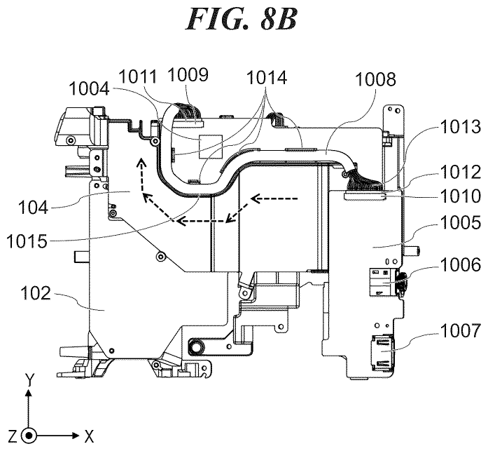

FIG. 8A and FIG. 8B are views that illustrate a connection state between the electrical substrates by the electrical wirings inside the image pickup apparatus 1, FIG. 8A shows a perspective view, and FIG. 8B shows a front view (a view when viewed from the +Z side). The plurality of electrical substrates disposed in the inside of the image pickup apparatus 1 are electrically connected to each other by the electrical wirings. An external connection terminal 1006, an external connection terminal 1007, and a second connector 1010 have been mounted on a third electrical substrate 1005. An electrical wiring 1008 is a cable made up of a plurality of electric wires 1013, and has a third connector 1011 attached to one end thereof and a fourth connector 1012 attached to the other end thereof. The third connector 1011 is connected to a first connector 1009 that has been mounted on the second electrical substrate 102, and the fourth connector 1012 is connected to the second connector 1010 that has been mounted on the third electrical substrate 1005. In this way, the second electrical substrate 102 and the third electrical substrate 1005 are electrically connected to each other via the electrical wiring 1008.

The electrical wiring 1008 has been arranged so as to creep (be routed) along an outer wall surface on the +Y side of the sensor duct unit 104 (hereinafter, referred to as “a side surface of the sensor duct unit 104”) by wiring regulating portions 1014 that have been provided on the sensor duct unit 104. In this way, by bringing the electrical wiring 1008 into contact with the side surface of the sensor duct unit 104, heat transfer from the electrical wiring 1008 to the sensor duct unit 104 becomes possible. The heat generated by the electronic component 1004 that has been mounted on the second electrical substrate 102 is heat-transferred to the first connector 1009 that has been mounted nearby by heat conduction of the wirings within the second electrical substrate 102 and the substrate itself. The heat that has been transferred to the first connector 1009 is transferred to the sensor duct unit 104 via the third connector 1011 and the electrical wiring 1008. In this way, the heat generated by the electronic component 1004 is capable of being transferred to the sensor duct unit 104 by using the electrical wiring 1008 as a heat transfer path, and is capable of being dissipated into the air flowing inside the sensor duct unit 104.

As shown in FIG. 8B, a curved portion 1015 is provided on the side surface of the sensor duct unit 104. By arranging the electrical wiring 1008 so that the electrical wiring 1008 creeps along a curved surface of the curved portion 1015 (so that the electrical wiring 1008 is routed along the curved surface of the curved portion 1015), the electrical wiring 1008 is capable of being made longer, and a contact area between the electrical wiring 1008 and the side surface of the sensor duct unit 104 is capable of being increased. As a result, it is possible to enhance the heat transfer effect from the electrical wiring 1008 to the sensor duct unit 104. In addition, generally, in a heat dissipation structure that uses a duct, since a high heat dissipation effect is capable of being achieved by increasing the area of contact with the air flowing inside the duct, the length of the duct in a direction in which the air flows within the duct is sometimes increased. In the image pickup apparatus 1, the heat dissipation effect is enhanced by making an arrangement path of the electrical wiring 1008 substantially parallel to a direction in which the air flows inside the sensor duct unit 104 as indicated by arrows in FIG. 8B.

It should be noted that the heat dissipation configuration of the electrical substrate by using the electrical wiring is not limited to the above configuration. The electrical wiring may be a flexible flat cable or a flexible printed circuit board, and the electrical wiring is not limited to being routed along the side surface of the duct (is not limited to creeping along the side surface of the duct), but may be routed along other surfaces (but may creep along other surfaces).

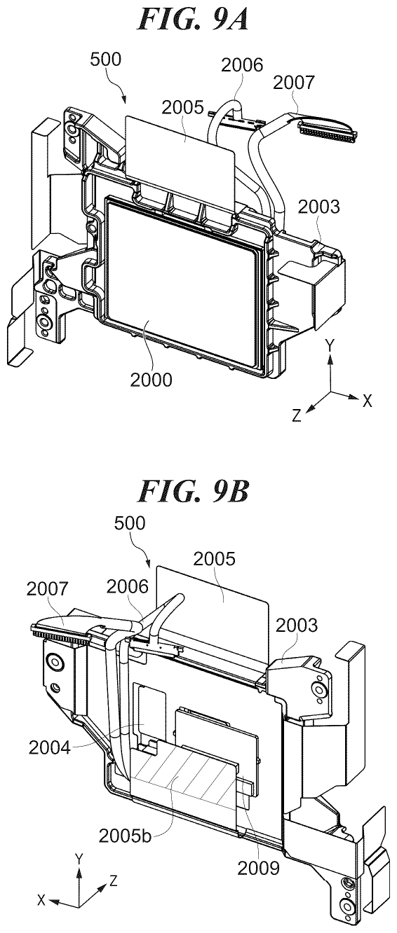

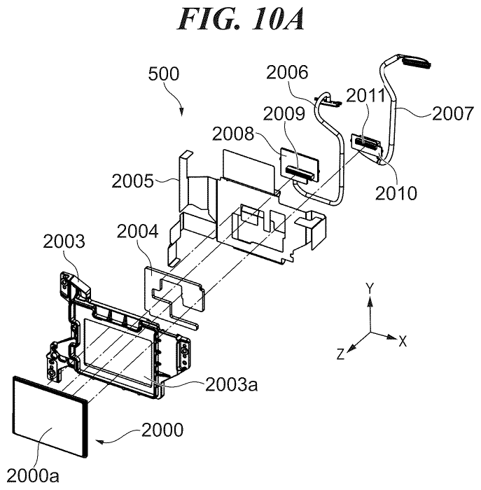

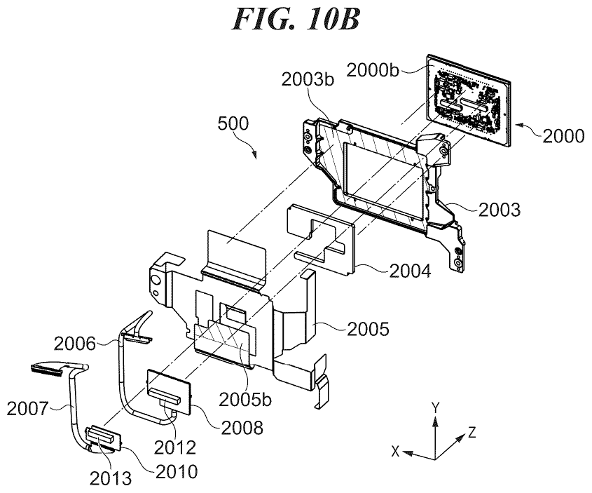

Next, the relationship between the sensor unit 500 and the sensor duct unit 104 will be described. FIG. 9A and FIG. 9B are external appearance perspective views of the sensor unit 500, and the sensor unit 500 is viewed from different directions in FIG. 9A and FIG. 9B. FIG. 10A and FIG. 10B are exploded perspective views of the sensor unit 500, and the sensor unit 500 is viewed from different directions in FIG. 10A and FIG. 10B.

The sensor unit 500 includes an image sensor 2000 (an image sensor 2000), a sensor holding member 2003, a heat conductive sheet 2005 (a first heat conductive member), a heat conductive plate 2004 (a second heat conductive member), an electrical wiring 2006, an electrical wiring 2007, a fourth electrical substrate 2008, and a fifth electrical substrate 2010.

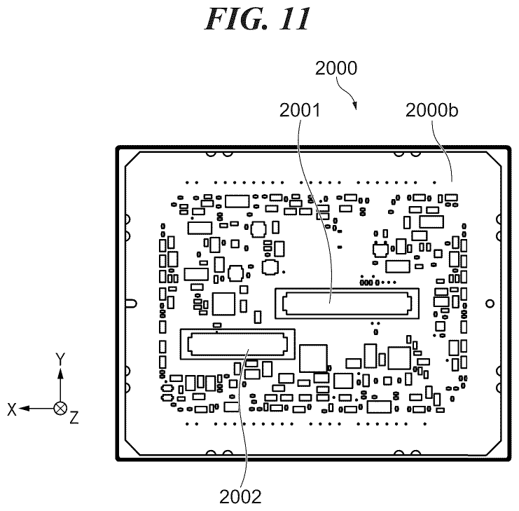

The image sensor 2000 includes an image pickup unit 2000a and a sensor substrate 2000b, and the image pickup unit 2000a has been fixed to the sensor substrate 2000b by soldering. The image sensor 2000 has been fixed to the sensor holding member 2003 with an adhesive. The sensor holding member 2003 has an opening 2003a for avoiding interference with the sensor substrate 2000b, and an attachment surface 2003b to which the heat conductive sheet 2005 is attached. The heat conductive plate 2004 has been formed in a flat plate shape that has a notch portion for avoiding interference with a first substrate-to-substrate connector 2001 (see FIG. 11) and a second substrate-to-substrate connector 2002 (see FIG. 11) that have been mounted on the sensor substrate 2000b. The sensor substrate 2000b is attached to one surface of the heat conductive plate 2004, and the heat conductive sheet 2005 is attached to the other surface of the heat conductive plate 2004.

FIG. 11 is a rear view of the sensor substrate 2000b. As shown in FIG. 11, a plurality of electrical elements, such as the first substrate-to-substrate connector 2001 and the second substrate-to-substrate connector 2002, have been mounted on the sensor substrate 2000b.

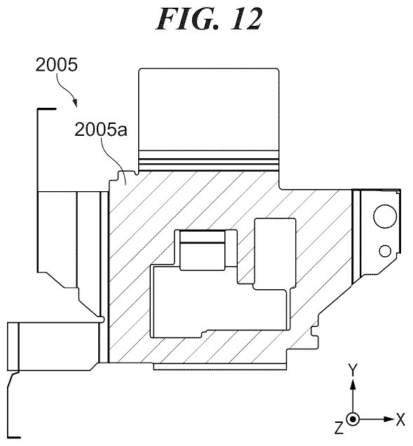

FIG. 12 is a front view of the heat conductive sheet 2005. As shown in FIG. 12, the heat conductive sheet 2005 has an attachment portion 2005a, and the attachment portion 2005a is attached to the attachment surface 2003b of the sensor holding member 2003, and the heat conductive plate 2004. In addition, the heat conductive sheet 2005 has a plurality of extending portions, which are thermally connected to members in the vicinity of the sensor holding member 2003.

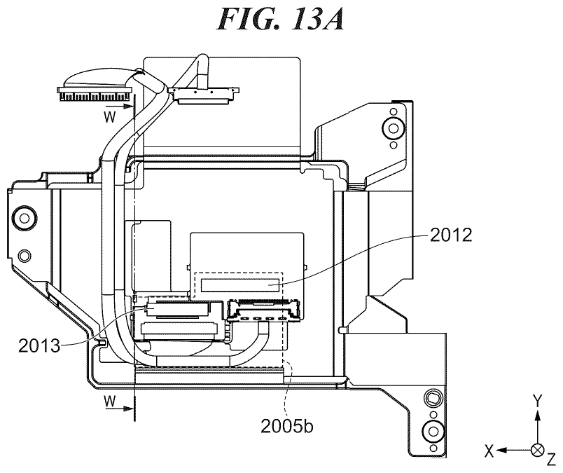

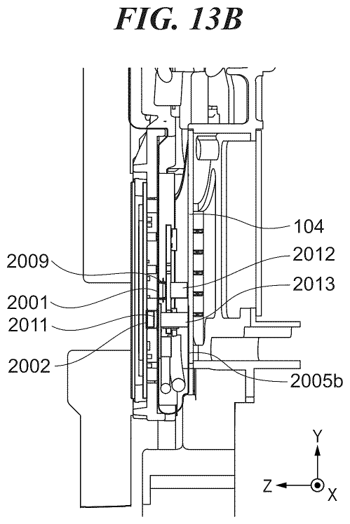

FIG. 13A is a rear view of the sensor unit 500, and FIG. 13B shows a sectional view taken in the direction of arrows W-W in FIG. 13A. In FIG. 13A, the outer shape of a clamping portion 2005b (see FIG. 10B) of the heat conductive sheet 2005 is indicated by a dashed line. As shown in FIG. 10A, FIG. 10B, and FIG. 13B, a third substrate-to-substrate connector 2009 has been mounted on the fourth electrical substrate 2008. The third substrate-to-substrate connector 2009 is connected to the first substrate-to-substrate connector 2001 of the sensor substrate 2000b, and is also connected to the electrical wiring 2006. In addition, a fourth substrate-to-substrate connector 2011 has been mounted on the fifth electrical substrate 2010. The fourth substrate-to-substrate connector 2011 is connected to the second substrate-to-substrate connector 2002 of the sensor substrate 2000b, and is also connected to the electrical wiring 2007. The electrical wiring 2006 and the electrical wiring 2007 are each electrically connected to the second electrical substrate 102. In this way, the fourth electrical substrate 2008 and the fifth electrical substrate 2010 are connected to the second electrical substrate 102.

An elastic member 2012 has been disposed on the opposite side of the third substrate-to-substrate connector 2009 on the fourth electrical substrate 2008, and an elastic member 2013 has been disposed on the opposite side of the fourth substrate-to-substrate connector 2011 on the fifth electrical substrate 2010. A dimension (a length) in the Z direction of the elastic member 2012 is longer than a space (a distance) in the Z direction between the fourth electrical substrate 2008 and the sensor duct unit 104. Similarly, a dimension (a length) in the Z direction of the elastic member 2013 is longer than a space (a distance) in the Z direction between the fifth electrical substrate 2010 and the sensor duct unit 104. Therefore, the elastic member 2012 and the elastic member 2013 are each in a compressed state, generating a repulsive force in the +Z direction. This repulsive force serves to clamp and hold the clamping portion 2005b of the heat conductive sheet 2005 between the elastic members 2012 and 2013, and the sensor duct unit 104, and also serves to prevent the third substrate-to-substrate connector 2009 and the fourth substrate-to-substrate connector 2011 from coming fall out.

As described with reference to FIGS. 9A to 13B, when the image pickup apparatus 1 is operating, the heat generated by the image sensor 2000 is mainly transferred to the sensor duct unit 104, making it possible to maintain the image sensor 2000 at or below a predetermined temperature.

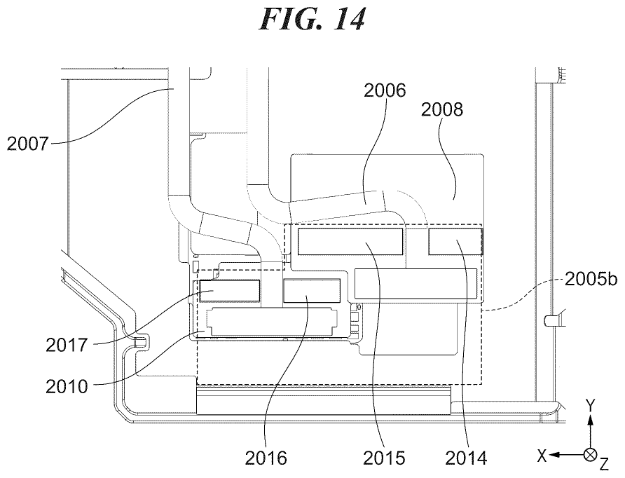

Next, a modification of the sensor unit 500 will be described. This modification differs from the sensor unit 500 in that an arrangement path of the electrical wiring 2006 and an arrangement path of the electrical wiring 2007 are changed and elastic members having a cord clamping function are disposed, and only this change point will be described with reference to FIG. 14.

FIG. 14 is a front view that illustrates the change point in the modification of the sensor unit 50. As shown in FIG. 14, an elastic member 2014 and an elastic member 2015 are disposed at a predetermined interval in the X direction on the opposite side of a mounting position of the third substrate-to-substrate connector 2009 on the fourth electrical substrate 2008, and a gap between the elastic member 2014 and the elastic member 2015 is used as the arrangement path of the electrical wiring 2006. Similarly, an elastic member 2016 and an elastic member 2017 are disposed at a predetermined interval in the X direction on the opposite side of a mounting position of the fourth substrate-to-substrate connector 2011 on the fifth electrical substrate 2010, and a gap between the elastic member 2016 and the elastic member 2016 is used as the arrangement path of the electrical wiring 2007. With this configuration, the elastic member 2014 and the elastic member 2015, and the elastic member 2016 and the elastic member 2017 are capable of having a clamping function for clamping the electrical wiring.

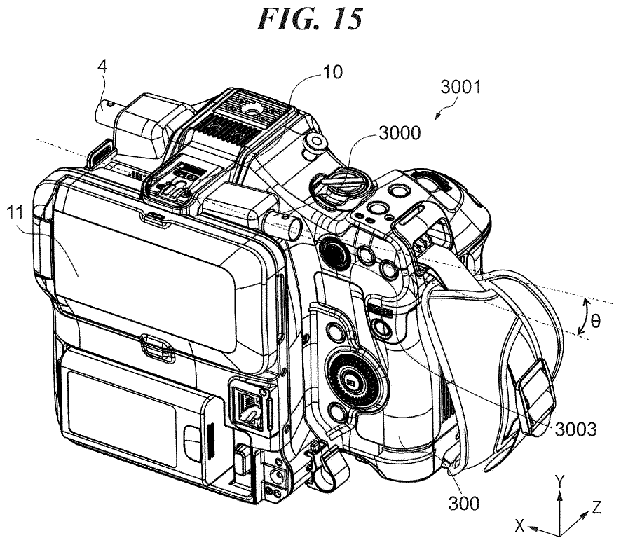

Next, another layout of the external connection terminal will be described. FIG. 15 is a perspective view of an image pickup apparatus 3001 that is a modification of the image pickup apparatus 1. The image pickup apparatus 3001 differs from the image pickup apparatus 1 in that the image pickup apparatus 3001 includes an external connection terminal 3000, but other configurations are the same as those of the image pickup apparatus 1, so hereinafter, only the differences will be described.

The external connection terminal 3000 is disposed at the rear (on the −Z side) than the rear surface of the grip unit 300 and at the front (on the +Z side) than the rear surface display unit 11, and is also disposed so as not to protrude upward (toward the +Y side) from the top surface of the accessory attachment portion 10. In addition, when the image pickup apparatus 3001 is in a normal position (that is, when the image pickup apparatus 3001 is in a state where the ZX plane is parallel to a horizontal plane and the +Y direction is vertically upward), an insertion port of the external connection terminal 3000 forms an angle θ with the horizontal plane and faces above the holding portion. Therefore, even in a state where an accessory (not shown) such as a strobe device has been attached to the accessory attachment portion 10, a cable is capable of being easily inserted into and removed from the external connection terminal 3000.

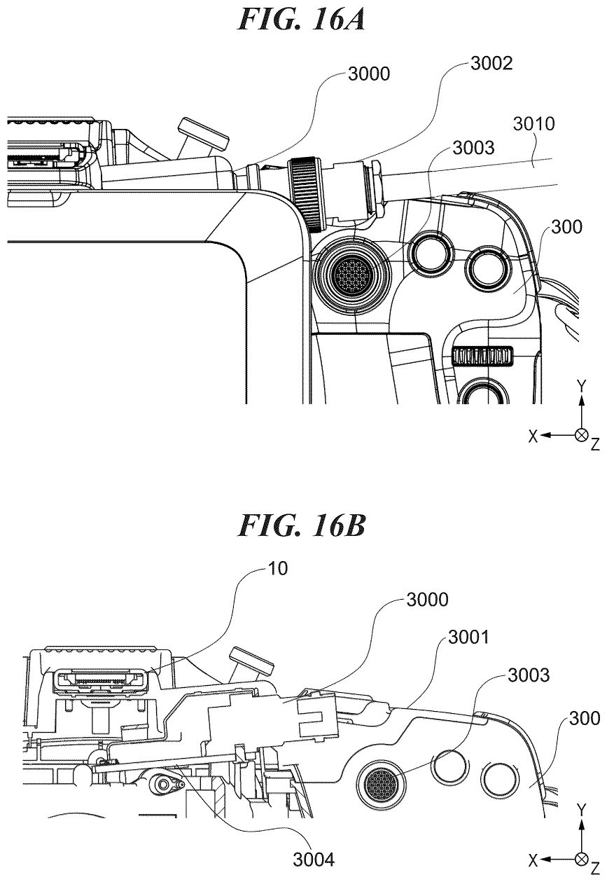

FIG. 16A is a partial rear view that shows a state in which a cable 3010 having a plug 3002 has been connected to the external connection terminal 3000. The grip unit 300 is provided with an operation portion 3003 that allows to be operated by the user's finger, but the external connection terminal 3000 and the plug 3002 that has been connected thereto do not overlap with the operation portion 3003 of the grip unit 300 when viewed from the Z direction. Therefore, even in the state in which the cable 3010 has been connected to the external connection terminal 3000, an operation with respect to the operation portion 3003 will not be impeded.

FIG. 16B is a rear view that shows an internal structure around the external connection terminal 3000. As shown in FIG. 16B, the external connection terminal 3000 has been mounted on a substrate 3004. The accessory attachment portion 10 is provided on the top surface of the image pickup apparatus 3001, and a part of the substrate 3004 overlaps with a part of the accessory attachment portion 10 when viewed from the Y direction. Here, the accessory attachment portion 10 needs to be provided on the uppermost surface of the apparatus main body so that the accessory is capable of being easily attached and detached, and since the accessory attachment portion 10 has been arranged at a protruding portion on the top surface of the image pickup apparatus 3001, a space is generated in the inside of the accessory attachment portion 10 on the lower side (the −Y side). By inserting a part of the substrate 3004, on which the external connection terminal 3000 has been mounted, into this space and effectively utilizing the empty space, it becomes possible to realize the miniaturization of the apparatus main body. It should be noted that although not shown, when viewed from the Y direction, not only the substrate 3004 but also a part of the external connection terminal 3000 may be arranged to overlap with the accessory attachment portion 10.

Although the present invention has been described above in detail based on its preferred embodiments, the present invention is not limited to these specific embodiments, and the present invention also includes various forms without departing from the gist of the present invention. Furthermore, each of the above-described embodiments merely shows one embodiment of the present invention, and each embodiment can be appropriately combined.

In the above-described embodiment, the notch portion 102a is provided in the second electrical substrate 102, and the electrical wiring 105 and the electrical wiring 106 that are connected to the connectors, which have been mounted along the one side of the notch portion 102a, are pressed down by the first electrical substrate 101, thereby enhancing the reliability of the electrical connection. Here, the shape of the electrical substrate is not necessarily limited to a rectangle, and in many cases, recess(es), extension(s) (protrusion(s)), bent part(s), etc. are appropriately provided depending on the internal configuration of the apparatus on which the electrical substrate is mounted. The present invention is also capable of being realized by a configuration in which an electrical wiring extending from one side of the outer circumference of one substrate or the bottom side of a recess of the one substrate is pressed by a protrusion or a bent part of another substrate. In addition, in the above-described embodiment, the present invention has been described as being applied to an image pickup apparatus, but the present invention is also capable of being applied to an electronic apparatus that includes a plurality of electrical substrates.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-079452, filed on May 15, 2024, which is hereby incorporated by reference herein in its entirety.

What is claimed is:

1. An image pickup apparatus comprising:
a first electrical substrate;
a second electrical substrate that has a notch portion, on which a first connector has been mounted along one side of the notch portion; and
an electrical wiring that has been connected to the first connector, and
wherein the first electrical substrate is disposed substantially perpendicular to the second electrical substrate in the notch portion, and a substrate surface of the first electrical substrate covers the electrical wiring.

2. The image pickup apparatus according to claim 1, wherein
the electrical wiring has a second connector connected to the first connector, and
the substrate surface of the first electrical substrate covers the electrical wiring from a first direction in which the second connector is connected to the first connector.

3. The image pickup apparatus according to claim 2, wherein
the first direction is substantially parallel to a substrate surface of the second electrical substrate.

4. The image pickup apparatus according to claim 3, wherein
the one side of the notch portion is substantially perpendicular to the first direction.

5. The image pickup apparatus according to claim 3, wherein
the one side of the notch portion is inclined at a predetermined angle with respect to a second direction perpendicular to the first direction.

6. The image pickup apparatus according to claim 1, wherein
the electrical wiring is in contact with the first electrical substrate at a non-mounting portion of the substrate surface of the first electrical substrate where no electrical components are mounted.

7. The image pickup apparatus according to claim 1, wherein
when viewed from a direction perpendicular to the substrate surface of the first electrical substrate, a long side of the first electrical substrate and a long side of the second electrical substrate are not parallel to each other.

8. The image pickup apparatus according to claim 1, further comprising:
a first external connection terminal that is mounted on the first electrical substrate and is disposed at a corner portion where a side surface and a top surface of an apparatus main body of the image pickup apparatus intersect, and
wherein a direction in which a cable is inserted into and removed from the first external connection terminal is a direction perpendicular to the side surface.

9. The image pickup apparatus according to claim 1, further comprising:
an electrical wiring that electrically connects a plurality of electrical substrates;
an air-cooling fan;
a duct, inside which air flows by the air-cooling fan being driven; and
a wiring regulating portion that holds the electrical wiring relative to the duct, and
wherein the electrical wiring has been arranged so as to be routed along the duct by the wiring regulating portion.

10. The image pickup apparatus according to claim 9, wherein
the duct has a curved portion, and
the electrical wiring has been arranged so as to be routed along a curved surface of the curved portion.

11. The image pickup apparatus according to claim 9, wherein
an arrangement path of the electrical wiring is substantially parallel to a flow of the air inside the duct.

12. The image pickup apparatus according to claim 9, further comprising:
two electrical substrates that are electrically connected to each other by a substrate-to-substrate connector; and
a heat conductive member that thermally connects one electrical substrate of the two electrical substrates to the duct, and
wherein the one electrical substrate is disposed between the other electrical substrate of the two electrical substrates and the duct,
an elastic member is disposed on an opposite side of the substrate-to-substrate connector on the one electrical substrate, and
a part of the heat conductive member is clamped by the elastic member and the duct.

13. The image pickup apparatus according to claim 12, wherein
an image sensor has been mounted on the other electrical substrate.

14. The image pickup apparatus according to claim 12, wherein
the elastic member is divided into two parts and the two parts are disposed at a predetermined gap between the two parts, and
the predetermined gap is used as an arrangement path of a part of electrical wiring provided inside the image pickup apparatus.

15. The image pickup apparatus according to claim 1, further comprising:
a holding portion for a user to hold the image pickup apparatus;
a step portion that does not overlap with the holding portion when viewed from rear of the image pickup apparatus and that protrudes toward the rear of the image pickup apparatus than the holding portion;
a display unit that has been disposed on a top surface of the step portion; and
a second external connection terminal that has been disposed on the step portion at rear than a rear surface of the holding portion and in front of the display unit, and
wherein an insertion port of the second external connection terminal faces the holding portion.

16. The image pickup apparatus according to claim 15, wherein
an operation portion is provided on the rear surface of the holding portion, and the second external connection terminal does not overlap with the operation portion when viewed from the rear of the image pickup apparatus.

17. The image pickup apparatus according to claim 15, wherein
when the image pickup apparatus is in a normal position, the insertion port of the second external connection terminal faces above the holding portion at a predetermined angle with respect to a horizontal plane.

18. The image pickup apparatus according to claim 15, further comprising:
an accessory attachment portion provided on a top surface of the image pickup apparatus, and
wherein the second external connection terminal does not protrude upward from a top surface of the accessory attachment portion.

19. The image pickup apparatus according to claim 18, wherein
when viewed from above the image pickup apparatus, a part of a substrate, on which the second external connection terminal has been mounted, overlaps with the accessory attachment portion.

20. An electronic apparatus comprising:
a first electrical substrate;
a second electrical substrate on which a first connector has been mounted; and
a cable that has a second connector connected to the first connector, and
wherein in a vicinity of the second connector connected to the first connector, a substrate surface of the first electrical substrate covers the cable from a direction in which the second connector is connected to the first connector.
